(19) United States
(12) Patent Application Publication
(10) Pub. No.: US 2026/0105287 A1
(43) Pub. Date: Apr. 16, 2026

(54) ENERGY-BASED DIFFUSION LANGUAGE MODEL

(71) Applicant: NVIDIA Corp., Santa Clara, CA (US)

(72) Inventors: Tomas Geffner, Santa Clara, CA (US); Minkai Xu, Palo Alto, CA (US); Arash Vahdat, San Mateo, CA (US); Weili Nie, Sunnyvale, CA (US); Yilun Xu, Santa Clara, CA (US); Karsten Julian Kreis, Vancouver (CA)

(73) Assignee: NVIDIA Corp., Santa Clara, CA (US)

(21) Appl. No.: 19/356,879

(22) Filed: Oct. 13, 2025

Related U.S. Application Data
(60) Provisional application No. 63/708,116, filed on Oct. 16, 2024.

(51) Int. Cl. G06N 3/0475; G06N 3/045

(52) U.S. Cl. CPC G06N 3/0475; G06N 3/045

(57) ABSTRACT

Energy-based diffusion models for transforming noisy inputs, the energy-based diffusion models including a denoiser model configured to transform a noisy input into a multiple candidate output predictions at each of a plurality of denoising iterations, and an energy-based model configured to transform the candidate output predictions at each denoising iteration into a single output prediction.

### CROSS-REFERENCE TO RELATED APPLICATIONS

This application claims priority and benefit under 35 U.S.C. 119 (e) to U.S. Application Ser. No. 63/708,116, “Energy-Based Diffusion Language Model”, filed on Oct. 16, 2024, the contents of which are incorporated herein by reference in their entirety.

### BACKGROUND

Despite progress in the design of autoregressive language models, alternative generative paradigms beyond left-to-right input-to-output transformation remain under-developed. Discrete diffusion models, with the capacity for parallel generation, have recently emerged as a possible alternative. These models underperform the autoregressive counterparts, and the performance gap increases with reductions in the number of sampling steps.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an energy-based diffusion model in accordance with one embodiment.

FIG. 2 depicts an algorithm for self-normalized importance sampling of an energy-based diffusion language model in accordance with one embodiment.

FIG. 3 depicts a training process for an energy-based model utilizing noise contrastive estimation, in accordance with one embodiment.

FIG. 4 depicts a parallel processing unit in accordance with one embodiment.

FIG. 5 depicts a general processing cluster in accordance with one embodiment.

FIG. 6 depicts a memory partition unit in accordance with one embodiment.

FIG. 7 depicts a streaming multiprocessor in accordance with one embodiment.

FIG. 8 depicts a processing system in accordance with one embodiment.

FIG. 9 depicts an exemplary processing system in accordance with another embodiment.

### DETAILED DESCRIPTION

An autoregressive neural network model is a type of neural network with utility in time series forecasting and sequence generation. An autoregressive neural network model operates on the principle that each output is a function of previous outputs, enabling it to model temporal dependencies effectively. Autoregressive neural network models are widely used in applications such as natural language processing for text generation, audio and speech synthesis, video synthesis, and any domain requiring sequence prediction and/or generation.

Generally, an autoregressive neural network model inputs a sequence of past time steps. For each time step, it applies previous sequence values to predict the next value in a sequence. The structure of an autoregressive neural network model may be recurrent, such as Recurrent Neural Networks (RNNs), Long Short-Term Memory networks (LSTMs), or Gated Recurrent Units (GRUs), which are designed to manage temporal dependencies and retain information over longer sequences.

During training, an autoregressive neural network model learns dependencies between current and past sequence values. It iteratively adjusts its weights to minimize the prediction error between its outputs and the ideal generated outputs. Once trained, an autoregressive neural network model may generate future values of a sequence by feeding its own previous predictions back as inputs, thereby forming a recursive sequence prediction mechanism.

Training and sampling of traditional autoregressive models involves the use of fixed ordering sequences, constraining their generation flexibility. Generation results from these models may be heavily conditioned on previous generations, leading to accumulated error (exposure bias).

The degradation of traditional diffusion model performance with reduction in sampling steps may arise from an imperfect approximation within the models. Disclosed herein are embodiments of energy-based diffusion models operating at full sequence level at each diffusion step, thereby improving the underlying approximations utilized in the models.

Another mechanism for discrete sequence generation utilizes a discrete diffusion model. Unlike autoregressive neural network models, discrete diffusion models progressively decode in parallel starting from a fully masked sequence. Conventional discrete diffusion models predict all missing tokens in parallel at each intermediate diffusion step, but the denoising joint distribution is simply parameterized as a product of token-wise independent distributions. As a result, intermediate denoising steps ignore sequence-level correlations, which may result in serious accumulated decoding errors and prevent efficient parallel decoding with fewer timesteps. For these reasons the performance of discrete diffusion models typically lags that of autoregressive neural network models in sequence generation.

An energy-based machine learning model is a model configured with a goal that associates a scalar energy value with a system's configuration, such that lower energy values represent more probable or desirable configurations. These models operate by defining an energy function, E(x, y), where x represents the model input y represents the possible labels or configurations.

During training, the model learns an energy function such that correct or target configurations have lower energy than incorrect ones. The energy function correlates inputs and possible outputs to a real-valued energy, capturing the compatibility between the inputs and the outputs. The model may be trained to minimize energy for correct configurations and to maximize energy for incorrect ones. This may be achieved using mechanisms such as gradient descent to adjust the parameters of the energy function (See FIG. 3).

During inference, the model infers configurations (i.e., predictions) that minimize the energy function, indicating high compatibility with the input data. Energy-based models may be utilized in various applications, including generative tasks and discriminative tasks, due to their flexibility in modeling and their capability to incorporate constraints and domain-specific knowledge.

The residual form of an energy-based model refers to expressing the energy function as a base function plus a residual correction, typically written as E_{θ}(x)=E₀ (x)+f_{θ}(x) where E₀ (x) is a simple reference energy (e.g., a Gaussian prior or known physical potential) and f_{θ}(x) is a residual term configured via training that adjusts or refines the base energy landscape. This is analogous to “residual learning” in neural networks (like ResNets) that, rather than directly learning the full mapping E_{θ}(x), learn only a correction f_{θ}(x) to a simpler baseline energy E₀ (x). The model starts from a physically or statistically reasonable prior E₀ (x) and learns only small modifications, improving training stability and interpretability.

The disclosed mechanisms comprise energy-based diffusion models in residual form, with parameters derived from a pretrained autoregressive model, or by finetuning a bidirectional transformer via noise contrastive estimation. The energy-based diffusion models comprise a novel family of discrete generative models with characteristics of both energy-based and diffusion-based models.

The disclosed mechanisms apply an efficient generation mechanism involving parallel ‘importance’ sampling. The disclosed models may outperform state-of-the-art diffusion models by a significant margin, and approach a level of perplexity found in autoregressive models. The disclosed mechanisms may provide a substantial increase in sampling speed over existing diffusion models without reducing generative performance.

The disclosed mechanisms comprise unnormalized energy-based neural network models that learn to jointly denoise the full sequence at each diffusion step. An energy based model may be configured for each denoising distribution p(xₜ−1|xₜ), where energy operates directly on the sequence level and captures the correlation between tokens.

To enable the efficient training and sampling of the unnormalized model, it may be structured in the residual form

$${p}_{E D L M} ( {x}_{t - 1} \vert {x}_{t} ) = {P}_{diffusion} ( {x}_{t - 1} \vert {x}_{t} ) \cdot {e}^{- E ( {x}_{t - 1} , {x}_{t} )} \qquad Eq . 1$$

applied over a set of pretrained diffusion models p_{diffusion}.

Configuration parameters (e.g., weights) of the disclosed energy-based diffusion models may be obtained from pretrained autoregressive models or by finetuning from bidirectional transformers via noise contrastive estimation, obviating the need for expensive maximum likelihood training. The disclosed mechanisms further correct for decoding error and enable rapid inference (generation) by implementing efficient importance sampling in parallel over samples from the diffusion proposal distribution.

When applying pre-trained autoregressive neural network models as the energy function, the disclosed mechanisms operate as parallel sampling systems from pretrained language models using diffusion models as the proposal distribution.

A Markov chain is a stochastic model that describes a sequence of possible events where the probability of each event depends solely on the state attained in the previous event. This principle, known as the Markov property, assumes that future states are independent of past states and determined solely by the present state. Markov chains may be applied to model randomly changing systems where it can be assumed that the system's future behavior depends only on its current state.

A diffusion process may be modelled by a Markov chain q(xₜ|xₜ−1)=Cat (xₜ; Qₜxₜ−1) that repeatedly multiplies x with matrices Qₜ over T discrete time steps. The disclosed mechanisms operate on a discrete space inputs of size m−1, augmented by a mask state with index m.

The marginal distributions at each timestep may be expressed in closed-form as q(xₜ|x)=Cat(xₜ;Q̅ₜxₜ)=Cat(xₜ;Qₜ . . . Q1x). This forward process comprises an interpolation between a clean data sample x and a reference distribution Cat(·; π) induced by Q̅ₜ:

$$q ( {x}_{t} \vert x ) = C a t ( {x}_{t} ; {α}_{t} {x}_{0} + ( 1 - {α}_{t} ) π ) \qquad Eq . 2$$

where αₜ∈[0, 1] is a strictly decreasing function with respect to step index t, with α₀≈1 and α₁≈0.

In the continuous time limit, for two arbitrary times 0≤s≤t≤1, the transition distributions may be expressed as q(xₜ|xₛ)=Cat(xₜ;α_{t|s}xₛ+(1−α_{t|s})π), where α_{t|s}=αₜ/αₛ. During each diffusion step s→t the token will jump to a sample from the prior distribution π with a probability of (1−α_{t|s}). The reverse of the forward process (posterior distribution) given x₀ may be expressed as

$$q ( {x}_{s} \vert {x}_{t} , {x}_{0} ) = C a t ( {x}_{s} ; \frac{[ {α}_{t \vert s} {x}_{t} + ( 1 - {α}_{t \vert s} ) 1 {π}^{T} {x}_{t} ] ⊙ [ {α}_{s} {x}_{0} + ( 1 - {α}_{s} ) π ]}{{α}_{t} {x}_{t}^{T} {x}_{0} + ( 1 - {α}_{t} ) {x}_{t}^{T} π} ) . \qquad Eq . 3$$

A posterior distribution in the context of a Markov process is the probability distribution that represents the updated beliefs about the states of the process after observing new inputs. The posterior distribution combines prior knowledge about the states (the prior distribution) with the likelihood of the observed inputs under different states.

In a masked diffusion (i.e., absorbing state) model the target distribution π is set to m, the size of the discrete state inputs. At each diffusion step t each token transitions to the ‘masked’ state m with some probability. The forward interpolation (Eq. (2)) in a mask diffusion process may be expressed as q(xₜ|x₀)=αₜx₀+(1−αₜ)m, and the posterior distribution (Eq. (3)) may be expressed as:

$$q ( {x}_{s} \vert {x}_{t} , {x}_{0} ) = \{ \begin{matrix}Cat ( {x}_{s} ; {x}_{t} ) & {x}_{t} \neq m \\ Cat ( {x}_{s} ; \frac{( 1 - {α}_{s} ) m + ( {α}_{s} - {α}_{t} ) {x}_{0}}{1 - {α}_{t}} ) & {x}_{t} = m\end{matrix} \qquad Eq . 4$$

During the training process, diffusion models are configured (learn) to operate as a backward model p_{θ}(xₛ|xₜ) that approximates the reverse of the forward process. Using Eq. (4), the backward model may be expressed as:

$${p}_{θ} ( {x}_{s} \vert {x}_{t} ) = q ( {x}_{s} \vert {x}_{t} , {x}_{0} = {μ}_{θ} ( {x}_{t} , t ) ) = \{ \begin{matrix}Cat ( {x}_{s} ; {x}_{t} ) , & {x}_{t} \neq m \\ Cat ( {x}_{s} ; \frac{( 1 - {α}_{s} ) m + ( {α}_{s} - {α}_{t} ) {μ}_{θ} ( {x}_{t} , t )}{1 - {α}_{t}} & {x}_{t} = m\end{matrix} \qquad Eq . 5$$

Conventional discrete diffusion models learn a denoising distribution μ_{θ}=p_{θ}(x₀|xₜ) that reproduces the true (accurate) reversal q(x₀|xₜ). Let x represent tokens of a sequence such that the model may be parameterized as a factorized denoising model:

$${p}_{θ} ( {x}_{0} \vert {x}_{t} ) = {\prod }_{i} {p}_{θ} ( {x}_{0}^{i} \vert {x}_{t} ) = {\prod }_{i} {μ}_{θ}^{i} ( {x}_{t} , t ) , \\ where {μ}_{θ} ( {x}_{t} , t ) = \{ \begin{matrix}softmax ( {f}_{θ} ( {x}_{t} , t ) ) & {x}_{t} \neq m \\ {x}_{t} & {x}_{t} = m\end{matrix} \qquad Eq . 6$$

During training, discrete diffusion models learn a conditional x₀ predictor operation for each denoising step t. Conventional discrete diffusion models learn μ(x_{t, t}) to directly predict independent distributions for each token in x₀.

The ‘predictor’ operator μ_{θ} predicts each token in x₀ independently. This factorization enables efficient execution of denoising step p_{θ}(xₛ|xₜ) by first sampling all x_{0|t} tokens from p_{θ}(x₀|xₜ) in parallel and then masking certain tokens according to the forward operation q(xₛ|xₜ, x_{0|t}). However, this parameterization ignores dependencies between tokens in the sequence, a fundamental limitation which implies that p_{θ}(x₀|xₜ) is highly unlikely to match the exact backward operation q(x₀|xₜ). Consequently the parallel sampling introduces accumulated errors due to the factorized denoising step p_{θ} not matching the original generative model p_{θ} for the joint distribution of the elements of x₀.

The disclosed mechanisms comprise a new family of energy-based discrete generative models that mitigate the accumulated error problem arising from the fundamental mismatching between p_{θ}(xₛ|xₜ) and q(x₀|xₜ) in conventional models.

Given diffused inputs xₜ at each timestep t, the disclosed mechanisms apply a generative denoising kernel as an unnormalized density:

$${P}_{θ , ϕ} ( {x}_{0} \vert {x}_{t} ) = {μ}_{θ} ( {x}_{0} \vert {x}_{t} ) \frac{exp ( - {E}_{ϕ} ( {x}_{0} , {x}_{t} , t ) )}{{Z}_{ϕ} ( {x}_{t} )} \qquad Eq . 7$$

where μ_{θ} is the pretrained diffusion model, E_{φ} is the energy introduced to capture the correlation in the x₀ sequence, and Z_{φ}(xₜ) is a normalizing factor referred to herein as a partition function. Herein, p_{θ,φ} denotes the joint model, E_{φ} the (residual) energy function. The pretrained model μ_{θ} is maintained in a fixed state, e.g., not evolved.

Computing the partition function is computationally impractical due to involving a summation over the entire space of x (the input space, i.e. model vocabulary), which is exponentially related to the sequence length. The disclosed mechanisms avoid computation of the partition function while efficiently training the parameters of the energy function Es so that the joint model distribution closely matches the true (desired) reversal q(x₀|xₜ).

Efficiently and accurately training energy-based models is a long-standing challenge in machine learning. Conventional maximum likelihood estimation training requires approximation of the participation function using Markov chain Monte Carlo (MCMC) sampling, which is computationally impractical for high dimensional training data.

The disclosed mechanisms efficiently train the energy function's parameters for the x₀ predictor p_{θ,φ}(x₀|xₜ). One such mechanism involves treating pretrained autoregressive language models as energy functions without any training, and efficiently sampling tokens as inputs in parallel. Another such mechanism involves fine-tuning the pretrained diffusion model via noise contrastive estimation, whereby the model is parameterized with bidirectional transformers and potentially captures richer correlations.

An autoregressive (AR) model trained over clean samples x0 may be expressed as

$${P}_{AR} ( {x}_{0} ) = {\prod }_{i p} {P}_{AR} ( {x}_{0}^{i} \vert {x}_{0}^{< i} ) .$$

Autoregressive neural network models are typically trained using clean samples x₀, not diffused data samples xₜ, rendering them unsuitable for denoising tasks. However in an absorbing discrete diffusion process, the diffused data samples xₜ resembles a clear sample set x₀ with certain tokens masked in the forward process. Specifically, let x̅₀=x₀[xₜ≠m] and x₀|x̅₀ denote the sets of unmasked and masked components in xₜ. Denoising transitions may be induced by

$${P}_{AR} ( {x}_{0} \vert {x}_{t} ) = {p}_{AR} ( {x}_{0} \vert {\overline{x}}_{0} ) = \frac{{p}_{AR} ( {x}_{0} / {\overline{x}}_{0} )}{{p}_{AR} ( {\overline{x}}_{0} )} = \frac{{p}_{AR} ( {x}_{0} )}{{p}_{AR} ( {\overline{x}}_{0} )} \qquad Eq . 8$$

where p_{AR} (x̅₀)=Σₓ_{₀}_{/x̅}_{₀}, p_{AR} (x₀/x̅₀, x̅₀) is a normalizing constant. This partition function involves a sum over the x₀ sample space and is impractical to compute. However, in the reversal of masked diffusion (Eq. (5)), the unmasked tokens x̅₀ are fixed, so that p_{AR} (x₀|xₜ) ∝p_{AR} (x₀) may be efficiently computed.

Sampling the autoregressive model p_{AR} (x₀|xₜ) at each denoising step is computationally expensive. However, the value of p_{AR} (x₀) is proportional to the posterior p_{AR} (x₀|xₜ) be used in the residual energy-based determination (Eq. 7) as a proxy for the value of q(x₀|xₜ). The approximate the optimal residual energy may therefore be determined by

$$= - log q ( {x}_{0} \vert {x}_{t} ) + log {p}_{θ} ( {x}_{0} \vert {x}_{t} ) - log Z {E}_{ϕ} ( {x}_{0} , {x}_{t} ) \approx - log {p}_{A R} ( {x}_{0} \vert {x}_{t} ) + log {p}_{θ} ( {x}_{0} \vert {x}_{t} ) - log Z , \\ where q ( {x}_{0} \vert {x}_{t} ) \approx {p}_{A R} ( {x}_{0} \vert {x}_{t} ) = - log {p}_{A R} ( {x}_{0} ) + log {p}_{θ} ( {x}_{0} \vert {x}_{t} ) + log {p}_{A R} ( {\overline{x}}_{0} ) - log Z \qquad Eq . 9$$

where −log p_{AR} (x₀)+log p_{θ}(x₀|xₜ) is the energy function and log p_{AR} (x̅₀)−log Z is the partition function.

The disclosed mechanisms may utilize a sampling process based on self-normalized importance sampling and p_{θ}(x₀|xₜ) as the proposal distribution. Sampling may be performed from an autoregressive language model as the target distribution, with the denoising distribution as the proposal distribution. In other words, the disclosed mechanisms may utilize parallel importance sampling from pretrained autoregressive language models.

In the diffusion reversal process (See Eq. 4), unmasked tokens are carried over directly from xₜ to x₀, i.e., q(x₀|xₜ)=Cat(·; xₜ) for xₜ≠m. The disclosed autoregressive energy-based diffusion models may carry over the unmasked tokens in each denoising step, by directly setting

$${p}_{A R} ( {x}_{0}^{i} , {x}_{0}^{< i} ) = {x}_{t}^{i} for {x}_{t} \neq m .$$

This “carry-over autoregressive” (coAR) implementation of an energy-based diffusion model enables the determination of

$${p}_{xoAR} ( {x}_{0} \vert {x}_{t} ) = \frac{{p}_{xoAR} ( {x}_{0} )}{{p}_{xoAR} ( {\overline{x}}_{0} )}$$

by determination of P_{coAR} (x₀). Carrying over those tokens from xₜ means that P_{coAR} (x̅₀)=1 and the exact denoising likelihood may be determined without estimating the partition function.

Another approach that the disclosed mechanisms may utilize involves training the parameters of the residual energy function by applying a conditional version of Noise Contrastive Estimation (NCE). Noise contrastive estimation for training applies contrastive samples from the data distribution and a noise distribution, with the noise distribution closely following the data distribution. Noise contrastive estimation also involves computing the likelihoods of these samples by model distribution and noise distribution. In the disclosed mechanisms, given sets of clean data x₀ and diffused data xₜ, the true posterior q(\hat{x}₀|xₜ,x₀) is set to the positive distribution and the denoising distribution p_{θ}(\hat{x}₀|xₜ) is set to the negative distribution. From the residual energy formulation (Eq. 7), the log-odds reduce to log p_{θ,φ}−log p_{θ}=−E_{φ}, and the objective is simplified into the binary classification objective

$${ℒ}_{N C E} ( ϕ ; θ ) = - {{x}_{0 \sim {p}_{data}} , {x}_{t} \sim q ( {x}_{t} \vert {x}_{0} )}_{} [ A + B ] \qquad Eq . 10$$

$$where$$

$$A = {x + ∼ q ( {\hat{x}}_{0} \vert {x}_{t} , {x}_{0} )}_{} log \frac{1}{1 + exp ( {E}_{ϕ} ( {x}_{+} , {x}_{t} , t ) )}$$

$$and$$

$$B = {{x}_{-} ∼ {p}_{θ} ( {\hat{x}}_{0} \vert {x}_{t} )}_{} log \frac{1}{1 + exp ( - {E}_{ϕ} ( {x}_{-} , {x}_{t} , t ) )}$$

Given the diffused sequence xₜ, x₊ represents positive data from the true posterior and x₋ represents negative data from the diffusion model. The true posterior q(\hat{x}₀|xₜ, x₀): =x₀ recovers the true data. The training of the energy function trains a conditional classifier to discriminate the real text and text generated by the denoiser used by the diffusion model. The training objective is configured to capture the correlation in x₀ generations, assigning negative energy to real data and positive energy to data produced by the denoiser network. As a result, the joint model p_{θ,φ} functions as a corrected denoising distribution enabled to account for correlations between tokens. An embodiment of a noise contrastive estimation training (configuration) process and logic for an energy-based diffusion model 102 is depicted in Algorithm 2 of FIG. 3. The energy-based diffusion model 102 is configured to correct each denoising step of a discrete diffusion using noise contrastive estimation.

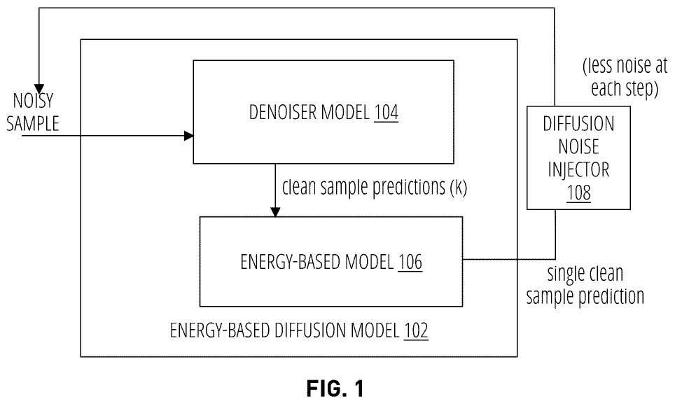

FIG. 1 depicts an energy-based diffusion model 102 in one embodiment. The energy-based diffusion model 102 comprises a denoiser model 104 configured to transform a noisy input into a plurality of output predictions at each of a plurality of denoising iterations, and an energy-based model 106 configured to transform the plurality of output predictions at each denoising iteration into a single output prediction. A diffusion noise injector 108 is configured to add noise to the single output prediction to generate a next noisy input to the denoiser model 104. The noisy input may comprise a natural language prompt (text sequence generation or audio synthesis, an image (video generation), or any input from which a sequential output may be generated.

The disclosed mechanisms may sample from an energy-based diffusion language model at each denoising step using self-normalizing importance sampling. An energy based model is configured to correct each denoising step of a discrete diffusion. The energy based model may be configured by retraining an autoregressive model or by training an energy based model via noise contrastive estimation.

Self-normalized importance sampling involves drawing candidate predictions from the diffusion (proposal) model, reweighting them by their learned energy scores, and normalizing over the sample batch. This yields a tractable approximation to expectations or probabilities under an unnormalized energy-based language distribution without estimating the partition function.

The joint model utilized for sampling is a product of the diffusion model p_{θ} and residual energy function E_{φ}. Given intermediate diffusion data xₜ at timestep t, efficient parallel sampling may be carried out by 1) sampling multiple x₀ predictions

$${\{ {x}_{0}^{i} \}}_{i = 1}^{k}$$

from the diffusion denoiser p_{θ}(x₀|xₜ), 2) feeding samples into the residual energy function in parallel to compute energies, and 3) resampling a single x₀ from the pool

$${\{ {x}_{0}^{i} \}}_{i = 1}^{k}$$

according to the energy values. The sampled x₀ is then fed into the posterior formulation q(xₛ|xₜ, x₀) to perform one-step denoising.

The utilization of importance may yield a significant reduction in parallel decoding error and may enable diffusion sampling with fewer denoising steps, reducing the overall sampling time. The disclosed mechanisms may configure an importance sampling window length w∈[0, 1] that sets the time window in which importance sampling is performed. Importance sampling is only performed within the time window t∈[1−w, 1].

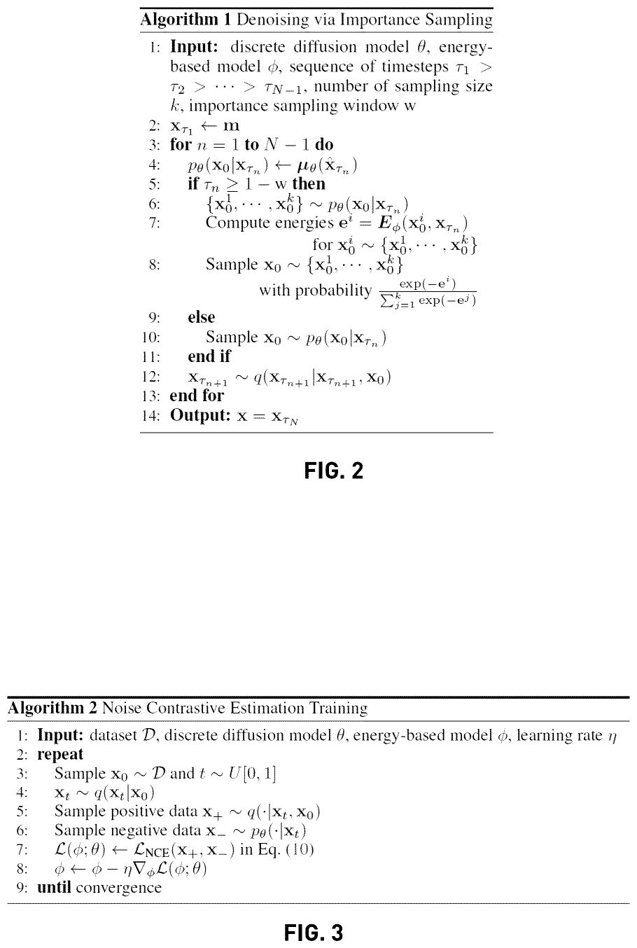

Importance sampling may contribute more to improving the quality of the model during the early stages of denoising. During the early sampling stages the diffusion model may be prone to make more errors in independent x₀ prediction due to lacking information about the full sequence. FIG. 2 depicts an algorithm for self-normalized importance sampling of an energy-based diffusion language model in accordance with one embodiment.

The energy-based diffusion models disclosed herein may be implemented for generative tasks in and/or by computing devices utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary computer systems will now be described that may be configured to implement the mechanisms disclosed herein, e.g., by configuring a media such as memory 402 and/or main memory 902 with machine-readable instructions that configure the computer systems to implement energy-based diffusion models in accordance with the disclosed embodiments.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

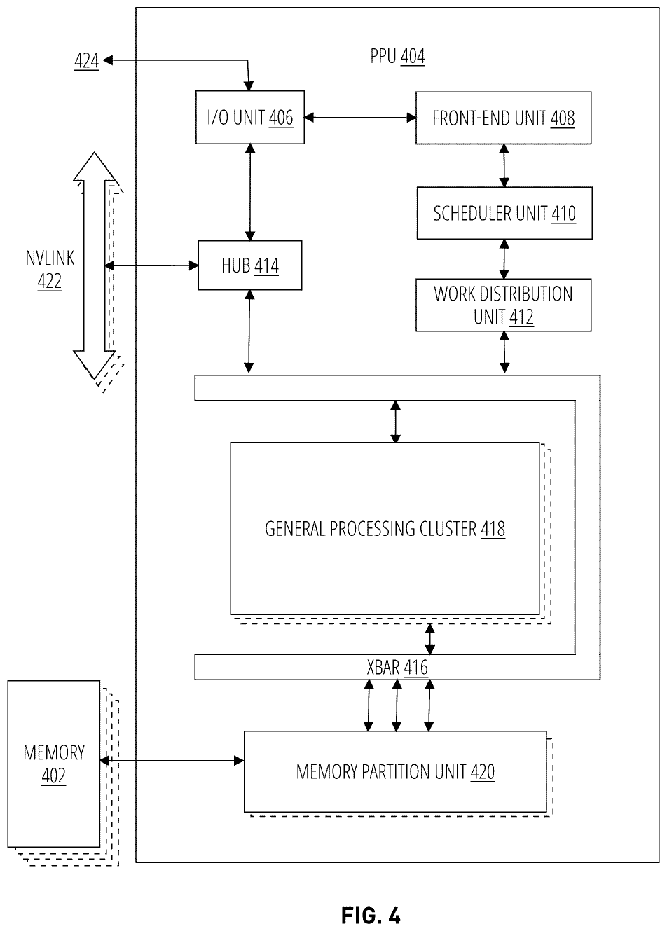

FIG. 4 depicts a parallel processing unit 404, in accordance with an embodiment. In an embodiment, the parallel processing unit 404 is a multi-threaded processor that is implemented on one or more integrated circuit devices. The parallel processing unit 404 is a latency hiding architecture designed to process many threads in parallel. A thread (e.g., a thread of execution) is an instantiation of a set of instructions configured to be executed by the parallel processing unit 404. In an embodiment, the parallel processing unit 404 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 404 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 404 modules may be configured to accelerate thousands of High Performance Computing (HPC), data center, and machine learning applications. The parallel processing unit 404 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the parallel processing unit 404 includes an I/O unit 406, a front-end unit 408, a scheduler unit 410, a work distribution unit 412, a hub 414, a crossbar 416, one or more general processing cluster 418 modules, and one or more memory partition unit 420 modules. The parallel processing unit 404 may be connected to a host processor or other parallel processing unit 404 modules via one or more high-speed NVLink 422 interconnects. The parallel processing unit 404 may be connected to a host processor or other peripheral devices via an interconnect 424. The parallel processing unit 404 may also be connected to a local memory comprising a number of memory 402 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 402 may comprise logic to configure the parallel processing unit 404 to carry out aspects of the techniques disclosed herein.

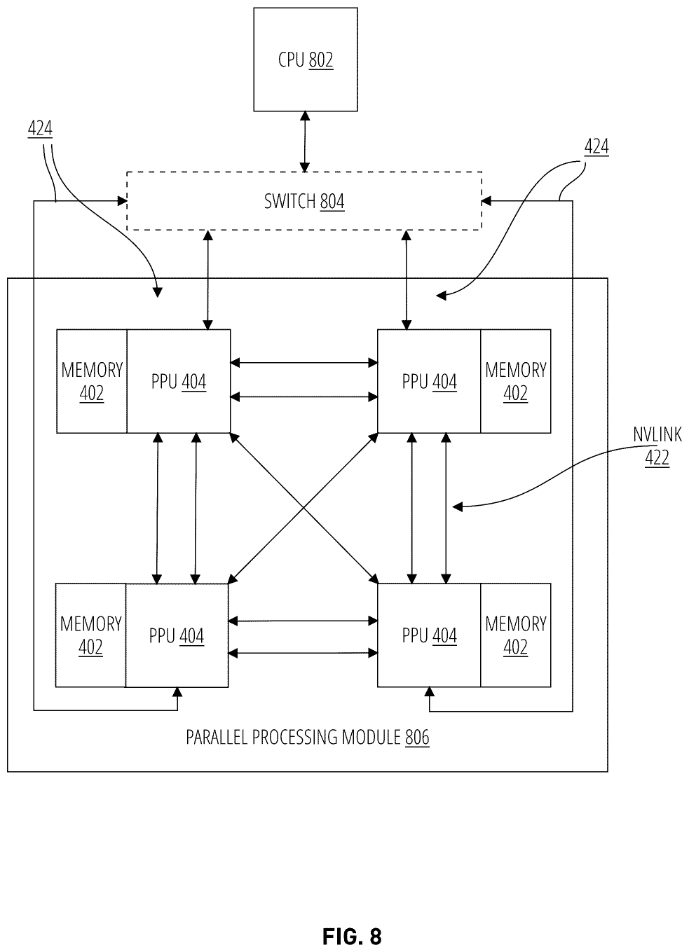

The NVLink 422 interconnect enables systems to scale and include one or more parallel processing unit 404 modules combined with one or more CPUs, supports cache coherence between the parallel processing unit 404 modules and CPUs, and CPU mastering. Data and/or commands may be transmitted by the NVLink 422 through the hub 414 to/from other units of the parallel processing unit 404 such as one or more copy engines, a video encoder, a video decoder, a power management unit, etc. (not explicitly shown). The NVLink 422 is described in more detail in conjunction with FIG. 8.

The I/O unit 406 is configured to transmit and receive communications (e.g., commands, data, etc.) from a host processor (not shown) over the interconnect 424. The I/O unit 406 may communicate with the host processor directly via the interconnect 424 or through one or more intermediate devices such as a memory bridge. In an embodiment, the I/O unit 406 may communicate with one or more other processors, such as one or more parallel processing unit 404 modules via the interconnect 424. In an embodiment, the I/O unit 406 implements a Peripheral Component Interconnect Express (PCIe) interface for communications over a PCIe bus and the interconnect 424 is a PCIe bus. In alternative embodiments, the I/O unit 406 may implement other types of well-known interfaces for communicating with external devices.

The I/O unit 406 decodes packets received via the interconnect 424. In an embodiment, the packets represent commands configured to cause the parallel processing unit 404 to perform various operations. The I/O unit 406 transmits the decoded commands to various other units of the parallel processing unit 404 as the commands may specify. For example, some commands may be transmitted to the front-end unit 408. Other commands may be transmitted to the hub 414 or other units of the parallel processing unit 404 such as one or more copy engines, a video encoder, a video decoder, a power management unit, etc. (not explicitly shown). In other words, the I/O unit 406 is configured to route communications between and among the various logical units of the parallel processing unit 404.

In an embodiment, a program executed by the host processor encodes a command stream in a buffer that provides workloads to the parallel processing unit 404 for processing. A workload may comprise several instructions and data to be processed by those instructions. The buffer is a region in a memory that is accessible (e.g., read/write) by both the host processor and the parallel processing unit 404. For example, the I/O unit 406 may be configured to access the buffer in a system memory connected to the interconnect 424 via memory requests transmitted over the interconnect 424. In an embodiment, the host processor writes the command stream to the buffer and then transmits a pointer to the start of the command stream to the parallel processing unit 404. The front-end unit 408 receives pointers to one or more command streams. The front-end unit 408 manages the one or more streams, reading commands from the streams and forwarding commands to the various units of the parallel processing unit 404.

The front-end unit 408 is coupled to a scheduler unit 410 that configures the various general processing cluster 418 modules to process tasks defined by the one or more streams. The scheduler unit 410 is configured to track state information related to the various tasks managed by the scheduler unit 410. The state may indicate which general processing cluster 418 a task is assigned to, whether the task is active or inactive, a priority level associated with the task, and so forth. The scheduler unit 410 manages the execution of a plurality of tasks on the one or more general processing cluster 418 modules.

The scheduler unit 410 is coupled to a work distribution unit 412 that is configured to dispatch tasks for execution on the general processing cluster 418 modules. The work distribution unit 412 may track a number of scheduled tasks received from the scheduler unit 410. In an embodiment, the work distribution unit 412 manages a pending task pool and an active task pool for each of the general processing cluster 418 modules. The pending task pool may comprise a number of slots (e.g., 32 slots) that contain tasks assigned to be processed by a particular general processing cluster 418. The active task pool may comprise a number of slots (e.g., 4 slots) for tasks that are actively being processed by the general processing cluster 418 modules. As a general processing cluster 418 finishes the execution of a task, that task is evicted from the active task pool for the general processing cluster 418 and one of the other tasks from the pending task pool is selected and scheduled for execution on the general processing cluster 418. If an active task has been idle on the general processing cluster 418, such as while waiting for a data dependency to be resolved, then the active task may be evicted from the general processing cluster 418 and returned to the pending task pool while another task in the pending task pool is selected and scheduled for execution on the general processing cluster 418.

The work distribution unit 412 communicates with the one or more general processing cluster 418 modules via crossbar 416. The crossbar 416 is an interconnect network that couples many of the units of the parallel processing unit 404 to other units of the parallel processing unit 404. For example, the crossbar 416 may be configured to couple the work distribution unit 412 to a particular general processing cluster 418. Although not shown explicitly, one or more other units of the parallel processing unit 404 may also be connected to the crossbar 416 via the hub 414.

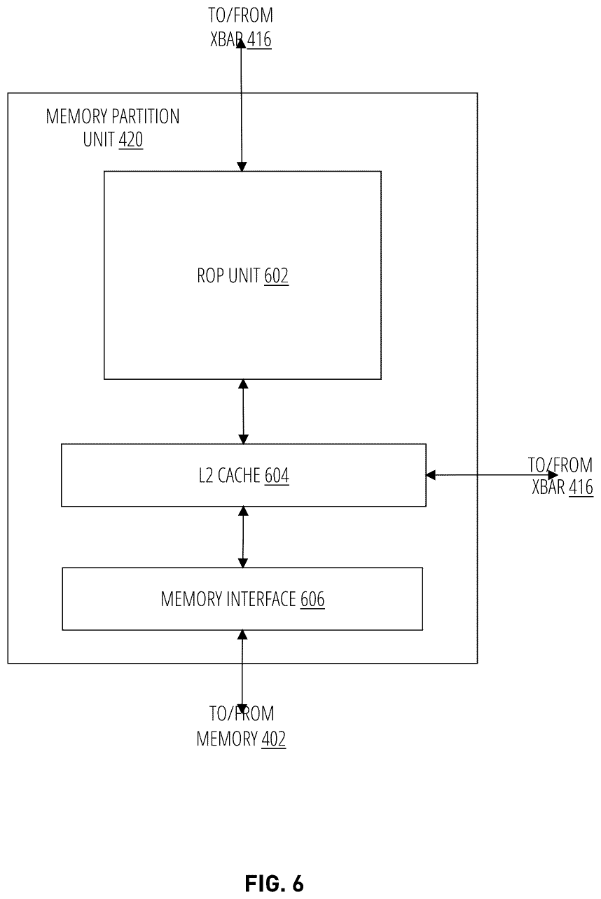

The tasks are managed by the scheduler unit 410 and dispatched to a general processing cluster 418 by the work distribution unit 412. The general processing cluster 418 is configured to process the task and generate results. The results may be consumed by other tasks within the general processing cluster 418, routed to a different general processing cluster 418 via the crossbar 416, or stored in the memory 402. The results can be written to the memory 402 via the memory partition unit 420 modules, which implement a memory interface for reading and writing data to/from the memory 402. The results can be transmitted to another parallel processing unit 404 or CPU via the NVLink 422. In an embodiment, the parallel processing unit 404 includes a number U of memory partition unit 420 modules that is equal to the number of separate and distinct memory 402 devices coupled to the parallel processing unit 404. A memory partition unit 420 will be described in more detail below in conjunction with FIG. 6.

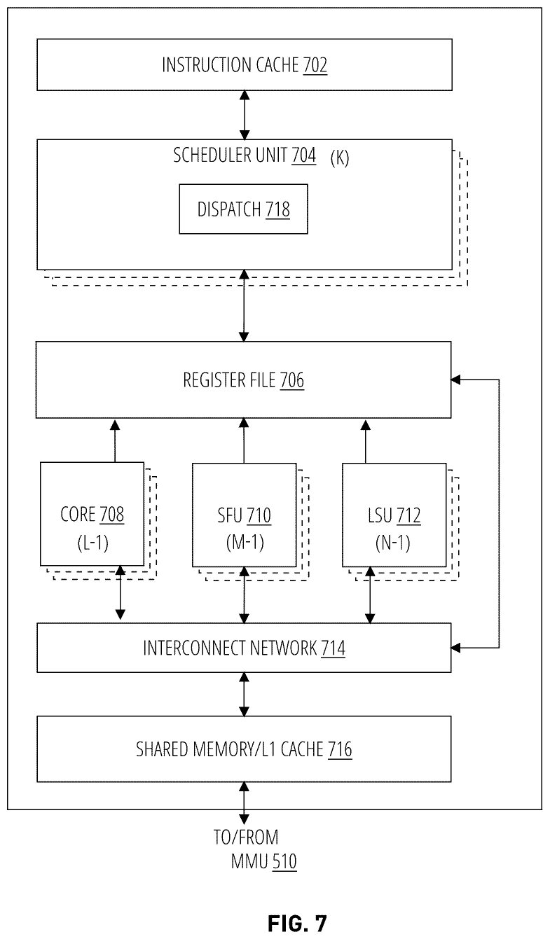

In an embodiment, a host processor executes a driver kernel that implements an application programming interface (API) that enables one or more applications executing on the host processor to schedule operations for execution on the parallel processing unit 404. In an embodiment, multiple compute applications are simultaneously executed by the parallel processing unit 404 and the parallel processing unit 404 provides isolation, quality of service (QoS), and independent address spaces for the multiple compute applications. An application may generate instructions (e.g., API calls) that cause the driver kernel to generate one or more tasks for execution by the parallel processing unit 404. The driver kernel outputs tasks to one or more streams being processed by the parallel processing unit 404. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 7.

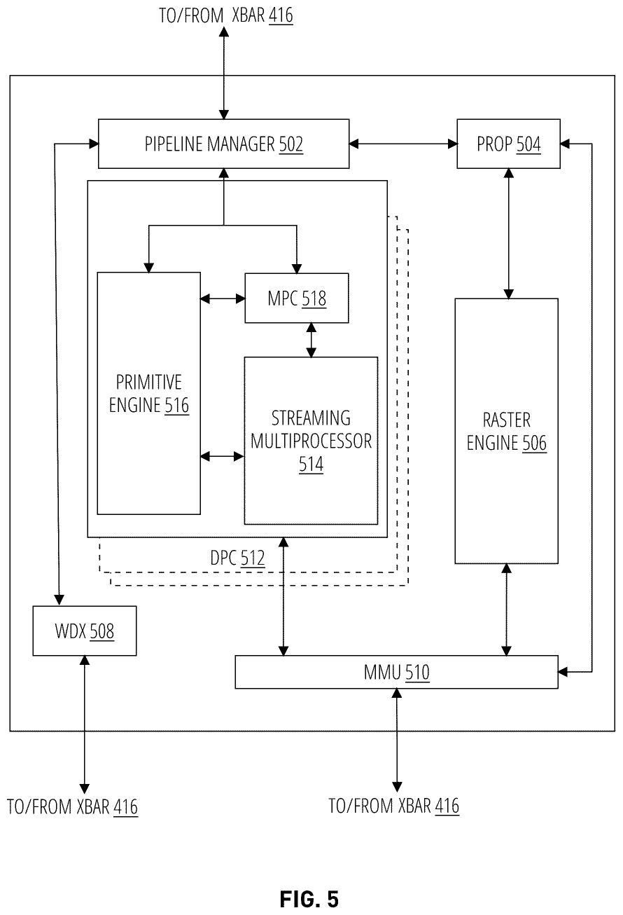

FIG. 5 depicts a general processing cluster 418 of the parallel processing unit 404 of FIG. 4, in accordance with an embodiment. As shown in FIG. 5, each general processing cluster 418 includes a number of hardware units for processing tasks. In an embodiment, each general processing cluster 418 includes a pipeline manager 502, a pre-raster operations unit 504, a raster engine 506, a work distribution crossbar 508, a memory management unit 510, and one or more data processing cluster 512. It will be appreciated that the general processing cluster 418 of FIG. 5 may include other hardware units in lieu of or in addition to the units shown in FIG. 5.

In an embodiment, the operation of the general processing cluster 418 is controlled by the pipeline manager 502. The pipeline manager 502 manages the configuration of the one or more data processing cluster 512 modules for processing tasks allocated to the general processing cluster 418. In an embodiment, the pipeline manager 502 may configure at least one of the one or more data processing cluster 512 modules to implement at least a portion of a graphics rendering pipeline. For example, a data processing cluster 512 may be configured to execute a vertex shader program on the programmable streaming multiprocessor 514. The pipeline manager 502 may also be configured to route packets received from the work distribution unit 412 to the appropriate logical units within the general processing cluster 418. For example, some packets may be routed to fixed function hardware units in the pre-raster operations unit 504 and/or raster engine 506 while other packets may be routed to the data processing cluster 512 modules for processing by the primitive engine 516 or the streaming multiprocessor 514. In an embodiment, the pipeline manager 502 may configure at least one of the one or more data processing cluster 512 modules to implement a neural network model and/or a computing pipeline.

The pre-raster operations unit 504 is configured to route data generated by the raster engine 506 and the data processing cluster 512 modules to a Raster Operations (ROP) unit, described in more detail in conjunction with FIG. 6. The pre-raster operations unit 504 may also be configured to perform optimizations for color blending, organize pixel data, perform address translations, and the like.

The raster engine 506 includes a number of fixed function hardware units configured to perform various raster operations. In an embodiment, the raster engine 506 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 506 comprises fragments to be processed, for example, by a fragment shader implemented within a data processing cluster 512.

Each data processing cluster 512 included in the general processing cluster 418 includes an M-pipe controller 518, a primitive engine 516, and one or more streaming multiprocessor 514 modules. The M-pipe controller 518 controls the operation of the data processing cluster 512, routing packets received from the pipeline manager 502 to the appropriate units in the data processing cluster 512. For example, packets associated with a vertex may be routed to the primitive engine 516, which is configured to fetch vertex attributes associated with the vertex from the memory 402. In contrast, packets associated with a shader program may be transmitted to the streaming multiprocessor 514.

The streaming multiprocessor 514 comprises a programmable streaming processor that is configured to process tasks represented by a number of threads. Each streaming multiprocessor 514 is multi-threaded and configured to execute a plurality of threads (e.g., 32 threads) from a particular group of threads concurrently. In an embodiment, the streaming multiprocessor 514 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 514 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 514 will be described in more detail below in conjunction with FIG. 7.

The memory management unit 510 provides an interface between the general processing cluster 418 and the memory partition unit 420. The memory management unit 510 may provide translation of virtual addresses into physical addresses, memory protection, and arbitration of memory requests. In an embodiment, the memory management unit 510 provides one or more translation lookaside buffers (TLBs) for performing translation of virtual addresses into physical addresses in the memory 402.

FIG. 6 depicts a memory partition unit 420 of the parallel processing unit 404 of FIG. 4, in accordance with an embodiment. As shown in FIG. 6, the memory partition unit 420 includes a raster operations unit 602, a level two cache 604, and a memory interface 606. The memory interface 606 is coupled to the memory 402. Memory interface 606 may implement 32, 64, 128, 1024-bit data buses, or the like, for high-speed data transfer. In an embodiment, the parallel processing unit 404 incorporates U memory interface 606 modules, one memory interface 606 per pair of memory partition unit 420 modules, where each pair of memory partition unit 420 modules is connected to a corresponding memory 402 device. For example, parallel processing unit 404 may be connected to up to Y memory 402 devices, such as high bandwidth memory stacks or graphics double-data-rate, version 5, synchronous dynamic random access memory, or other types of persistent storage.

In an embodiment, the memory interface 606 implements an HBM2 memory interface and Y equals half U. In an embodiment, the HBM2 memory stacks are located on the same physical package as the parallel processing unit 404, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 402 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 404 modules process very large datasets and/or run applications for extended periods.

In an embodiment, the parallel processing unit 404 implements a multi-level memory hierarchy. In an embodiment, the memory partition unit 420 supports a unified memory to provide a single unified virtual address space for CPU and parallel processing unit 404 memory, enabling data sharing between virtual memory systems. In an embodiment the frequency of accesses by a parallel processing unit 404 to memory located on other processors is traced to ensure that memory pages are moved to the physical memory of the parallel processing unit 404 that is accessing the pages more frequently. In an embodiment, the NVLink 422 supports address translation services allowing the parallel processing unit 404 to directly access a CPU's page tables and providing full access to CPU memory by the parallel processing unit 404.

In an embodiment, copy engines transfer data between multiple parallel processing unit 404 modules or between parallel processing unit 404 modules and CPUs. The copy engines can generate page faults for addresses that are not mapped into the page tables. The memory partition unit 420 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 402 or other system memory may be fetched by the memory partition unit 420 and stored in the level two cache 604, which is located on-chip and is shared between the various general processing cluster 418 modules. As shown, each memory partition unit 420 includes a portion of the level two cache 604 associated with a corresponding memory 402 device. Lower level caches may then be implemented in various units within the general processing cluster 418 modules. For example, each of the streaming multiprocessor 514 modules may implement an L1 cache. The L1 cache is private memory that is dedicated to a particular streaming multiprocessor 514. Data from the level two cache 604 may be fetched and stored in each of the L1 caches for processing in the functional units of the streaming multiprocessor 514 modules. The level two cache 604 is coupled to the memory interface 606 and the crossbar 416.

The raster operations unit 602 performs graphics raster operations related to pixel color, such as color compression, pixel blending, and the like. The raster operations unit 602 also implements depth testing in conjunction with the raster engine 506, receiving a depth for a sample location associated with a pixel fragment from the culling engine of the raster engine 506. The depth is tested against a corresponding depth in a depth buffer for a sample location associated with the fragment. If the fragment passes the depth test for the sample location, then the raster operations unit 602 updates the depth buffer and transmits a result of the depth test to the raster engine 506. It will be appreciated that the number of partition memory partition unit 420 modules may be different than the number of general processing cluster 418 modules and, therefore, each raster operations unit 602 may be coupled to each of the general processing cluster 418 modules. The raster operations unit 602 tracks packets received from the different general processing cluster 418 modules and determines which general processing cluster 1 that a result generated by the raster operations unit 602 is routed to through the crossbar 416. Although the raster operations unit 602 is included within the memory partition unit 420 in FIG. 6, in other embodiment, the raster operations unit 602 may be outside of the memory partition unit 420. For example, the raster operations unit 602 may reside in the general processing cluster 418 or another unit.

FIG. 7 illustrates the streaming multiprocessor 514 of FIG. 5, in accordance with an embodiment. As shown in FIG. 7, the streaming multiprocessor 514 includes an instruction cache 702, one or more scheduler unit 704 modules (e.g., such as scheduler unit 410), a register file 706, one or more processing core 708 modules, one or more special function unit 710 modules, one or more load/store unit 712 modules, an interconnect network 714, and a shared memory/L1 cache 716.

As described above, the work distribution unit 412 dispatches tasks for execution on the general processing cluster 418 modules of the parallel processing unit 404. The tasks are allocated to a particular data processing cluster 512 within a general processing cluster 418 and, if the task is associated with a shader program, the task may be allocated to a streaming multiprocessor 514. The scheduler unit 410 receives the tasks from the work distribution unit 412 and manages instruction scheduling for one or more thread blocks assigned to the streaming multiprocessor 514. The scheduler unit 704 schedules thread blocks for execution as warps of parallel threads, where each thread block is allocated at least one warp. In an embodiment, each warp executes 32 threads. The scheduler unit 704 may manage a plurality of different thread blocks, allocating the warps to the different thread blocks and then dispatching instructions from the plurality of different cooperative groups to the various functional units (e.g., core 708 modules, special function unit 710 modules, and load/store unit 712 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 718 unit is configured within the scheduler unit 704 to transmit instructions to one or more of the functional units. In one embodiment, the scheduler unit 704 includes two dispatch 718 units that enable two different instructions from the same warp to be dispatched during each clock cycle. In alternative embodiments, each scheduler unit 704 may include a single dispatch 718 unit or additional dispatch 718 units.

Each streaming multiprocessor 514 includes a register file 706 that provides a set of registers for the functional units of the streaming multiprocessor 514. In an embodiment, the register file 706 is divided between each of the functional units such that each functional unit is allocated a dedicated portion of the register file 706. In another embodiment, the register file 706 is divided between the different warps being executed by the streaming multiprocessor 514. The register file 706 provides temporary storage for operands connected to the data paths of the functional units.

Each streaming multiprocessor 514 comprises L processing core 708 modules. In an embodiment, the streaming multiprocessor 514 includes a large number (e.g., 128, etc.) of distinct processing core 708 modules. Each core 708 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 708 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 708 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 514 also comprises M special function unit 710 modules that perform special functions (e.g., attribute evaluation, reciprocal square root, and the like). In an embodiment, the special function unit 710 modules may include a tree traversal unit configured to traverse a hierarchical tree data structure. In an embodiment, the special function unit 710 modules may include texture unit configured to perform texture map filtering operations. In an embodiment, the texture units are configured to load texture maps (e.g., a 2D array of texels) from the memory 402 and sample the texture maps to produce sampled texture values for use in shader programs executed by the streaming multiprocessor 514. In an embodiment, the texture maps are stored in the shared memory/L1 cache 716. The texture units implement texture operations such as filtering operations using mip-maps (e.g., texture maps of varying levels of detail). In an embodiment, each streaming multiprocessor 514 includes two texture units.

Each streaming multiprocessor 514 also comprises N load/store unit 712 modules that implement load and store operations between the shared memory/L1 cache 716 and the register file 706. Each streaming multiprocessor 514 includes an interconnect network 714 that connects each of the functional units to the register file 706 and the load/store unit 712 to the register file 706 and shared memory/L1 cache 716. In an embodiment, the interconnect network 714 is a crossbar that can be configured to connect any of the functional units to any of the registers in the register file 706 and connect the load/store unit 712 modules to the register file 706 and memory locations in shared memory/L1 cache 716.

The shared memory/L1 cache 716 is an array of on-chip memory that allows for data storage and communication between the streaming multiprocessor 514 and the primitive engine 516 and between threads in the streaming multiprocessor 514. In an embodiment, the shared memory/L1 cache 716 comprises 128 KB of storage capacity and is in the path from the streaming multiprocessor 514 to the memory partition unit 420. The shared memory/L1 cache 716 can be used to cache reads and writes. One or more of the shared memory/L1 cache 716, level two cache 604, and memory 402 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 716 enables the shared memory/L1 cache 716 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 4, are bypassed, creating a much simpler programming model. In the general purpose parallel computation configuration, the work distribution unit 412 assigns and distributes blocks of threads directly to the data processing cluster 512 modules. The threads in a block execute the same program, using a unique thread ID in the calculation to ensure each thread generates unique results, using the streaming multiprocessor 514 to execute the program and perform calculations, shared memory/L1 cache 716 to communicate between threads, and the load/store unit 712 to read and write global memory through the shared memory/L1 cache 716 and the memory partition unit 420. When configured for general purpose parallel computation, the streaming multiprocessor 514 can also write commands that the scheduler unit 410 can use to launch new work on the data processing cluster 512 modules.

The parallel processing unit 404 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 404 is embodied on a single semiconductor substrate. In another embodiment, the parallel processing unit 404 is included in a system-on-a-chip (SoC) along with one or more other devices such as additional parallel processing unit 404 modules, the memory 402, a reduced instruction set computer (RISC) CPU, a memory management unit (MMU), a digital-to-analog converter (DAC), and the like.

In an embodiment, the parallel processing unit 404 may be included on a graphics card that includes one or more memory devices. The graphics card may be configured to interface with a PCIe slot on a motherboard of a desktop computer. In yet another embodiment, the parallel processing unit 404 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 8 is a conceptual diagram of a processing system implemented using the parallel processing unit 404 of FIG. 4, in accordance with an embodiment. The processing system includes a central processing unit 802, an switch 804, and multiple parallel processing unit 404 modules each and respective memory 402 modules. The switch 804 is depicted with dashed lines, indicating that it is optional in some embodiments.

The NVLink 422 provides high-speed communication links between each of the parallel processing unit 404 modules. Although a particular number of NVLink 422 and interconnect 424 connections are illustrated in FIG. 8, the number of connections to each parallel processing unit 404 and the central processing unit 802 may vary. The switch 804 interfaces between the interconnect 424 and the central processing unit 802. The parallel processing unit 404 modules, memory 402 modules, and NVLink 422 connections may be situated on a single semiconductor platform to form a parallel processing module 806. In an embodiment, the switch 804 supports two or more protocols to interface between various different connections and/or links.

In another embodiment (not shown), the NVLink 422 provides one or more high-speed communication links between each of the parallel processing unit modules (parallel processing unit 404, parallel processing unit 404, parallel processing unit 404, and parallel processing unit 404) and the central processing unit 802 and the switch 804 (when present) interfaces between the interconnect 424 and each of the parallel processing unit modules. The parallel processing unit modules, memory 402 modules, and interconnect 424 may be situated on a single semiconductor platform to form a parallel processing module 806. In yet another embodiment (not shown), the interconnect 424 provides one or more communication links between each of the parallel processing unit modules and the central processing unit 802 and the switch 804 interfaces between each of the parallel processing unit modules using the NVLink 422 to provide one or more high-speed communication links between the parallel processing unit modules. In another embodiment (not shown), the NVLink 422 provides one or more high-speed communication links between the parallel processing unit modules and the central processing unit 802 through the switch 804. In yet another embodiment (not shown), the interconnect 424 provides one or more communication links between each of the parallel processing unit modules directly. One or more of the NVLink 422 high-speed communication links may be implemented as a physical NVLink interconnect or either an on-chip or on-die interconnect using the same protocol as the NVLink 422.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 806 may be implemented as a circuit board substrate and each of the parallel processing unit modules and/or memory 402 modules may be packaged devices. In an embodiment, the central processing unit 802, switch 804, and the parallel processing module 806 are situated on a single semiconductor platform.

In an embodiment, each parallel processing unit module includes six NVLink 422 interfaces (as shown in FIG. 8, five NVLink 422 interfaces are included for each parallel processing unit module). The NVLink 422 may be operated exclusively for PPU-to-PPU communication as shown in FIG. 8, or some combination of PPU-to-PPU and PPU-to-CPU, when the central processing unit 802 also includes one or more NVLink 422 interfaces.

In an embodiment, the NVLink 422 allows direct load/store/atomic access from the central processing unit 802 to each parallel processing unit module's memory 402. In an embodiment, the NVLink 422 supports coherency operations, allowing data read from the memory 402 modules to be stored in the cache hierarchy of the central processing unit 802, reducing cache access latency for the central processing unit 802. In an embodiment, the NVLink 422 includes support for Address Translation Services (ATS), enabling the parallel processing unit module to directly access page tables within the central processing unit 802. One or more of the NVLink 422 may also be configured to operate in a low-power mode.

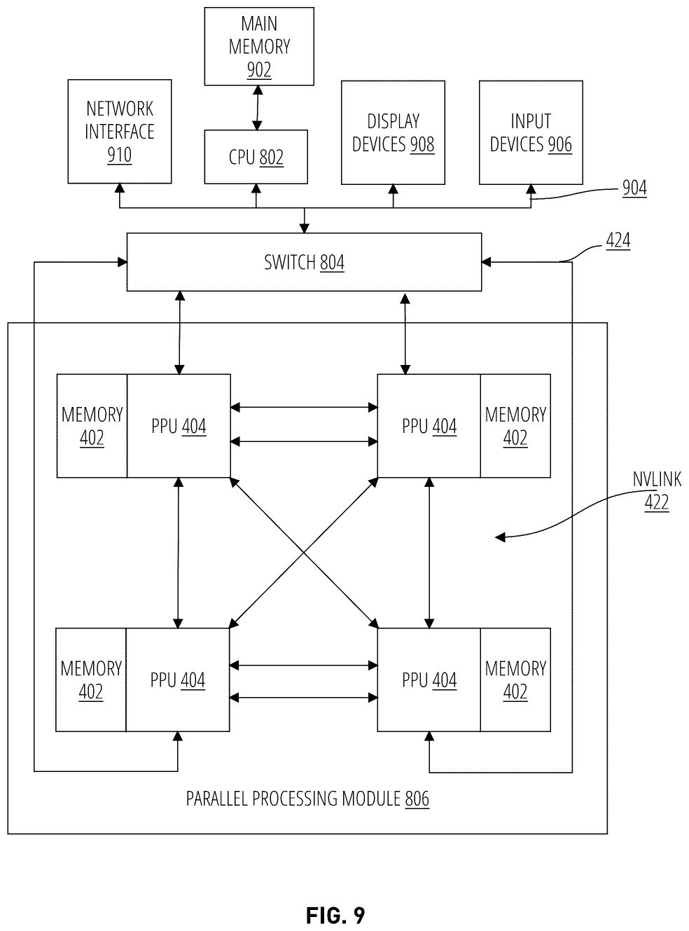

FIG. 9 depicts an exemplary processing system in which the various architecture and/or functionality of the various previous embodiments may be implemented. As shown, an exemplary processing system is provided including at least one central processing unit 802 that is connected to a communications bus 904. The communication communications bus 904 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 902. Control logic (software) and data are stored in the main memory 902 which may take the form of random access memory (RAM). For simplicity of illustration, the main memory 902 may be understood to comprise other forms of bulk memory, including non-volatile memory technologies.

The exemplary processing system also includes input devices 906, the parallel processing module 806, and display devices 908, e.g. a conventional CRT (cathode ray tube), LCD (liquid crystal display), LED (light emitting diode), plasma display or the like. User input may be received from the input devices 906, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 910 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 902 and/or the secondary storage. Such computer programs, when executed, enable the exemplary processing system to perform various functions. The main memory 902, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 energy-based diffusion model
104 denoiser model
106 energy-based model
108 diffusion noise injector
402 memory
404 parallel processing unit
406 I/O unit
408 front-end unit
410 scheduler unit
412 work distribution unit
414 hub
416 crossbar
418 general processing cluster
420 memory partition unit
422 NVLink
424 interconnect
502 pipeline manager
504 pre-raster operations unit
506 raster engine
508 work distribution crossbar
510 memory management unit
512 data processing cluster
514 streaming multiprocessor
516 primitive engine
518 M-pipe controller
602 raster operations unit
604 level two cache
606 memory interface
702 instruction cache
704 scheduler unit
706 register file
708 core
710 special function unit
712 load/store unit
714 interconnect network
716 shared memory/L1 cache
718 dispatch
802 central processing unit
804 switch
806 parallel processing module
902 main memory
904 communications bus
906 input devices
908 display devices
910 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude non-transitory machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. An energy-based diffusion model comprising:
a denoiser model configured to transform a noisy input into a plurality of output predictions at each of a plurality of denoising iterations; and
an energy-based model configured to transform the plurality of output predictions at each denoising iteration into a single output prediction.

2. The energy-based diffusion model of claim 1, wherein the energy-based model comprises an unnormalized energy-based neural network.

3. The energy-based diffusion model of claim 1, wherein the energy-based model is unnormalized.

4. The energy-based diffusion model of claim 1, wherein the energy-based model is configured to apply a generative denoising kernel as an unnormalized density.

5. The energy-based diffusion model of claim 1, wherein the energy-based model is configured to implement parallel importance sampling of the output predictions from the denoiser model.

6. The energy-based diffusion model of claim 3, wherein the energy-based model comprises a residual form.

7. The energy-based diffusion model of claim 1, further comprising:
a noise injector configured to add noise to the single output prediction to generate a next noisy input to the denoiser model.

8. The energy-based diffusion model of claim 1, wherein the energy-based model comprises a bidirectional transformer.

9. The energy-based diffusion model of claim 8, wherein the energy-based model is configured via noise contrastive estimation.

10. The energy-based diffusion model of claim 1, wherein the energy-based model comprises an autoregressive model.

11. A process for generating sequential outputs from an energy-based diffusion model, the process comprising:
transforming a noisy input with a denoiser model into a plurality of output predictions at each of a plurality of denoising iterations; and
transforming the plurality of output predictions at each denoising iteration into a single output prediction with an energy-based model.

12. A non-volatile machine-readable media comprising instructions that, when applied to one or more data processor of a computer system, configure the computer system to:
apply a denoiser model to transform a noisy input into a plurality of output predictions at each of a plurality of denoising iterations; and
apply an energy-based model to transform the plurality of output predictions at each denoising iteration into a single output prediction.

13. The non-volatile machine-readable media of claim 12, wherein the energy-based model comprises an unnormalized energy-based neural network.

14. The non-volatile machine-readable media of claim 12, wherein the energy-based model is unnormalized.

15. The non-volatile machine-readable media of claim 12, wherein the energy-based model is configured to apply a generative denoising kernel as an unnormalized density.

16. The non-volatile machine-readable media of claim 12, wherein the energy-based model is configured to implement parallel importance sampling of the output predictions from the denoiser model.

17. The non-volatile machine-readable media of claim 14, wherein the energy-based model comprises a residual form.

18. The non-volatile machine-readable media of claim 12, further comprising instructions that, when applied to the one or more data processor of the computer system, further configure the computer system to:
apply a noise injector to add noise to the single output prediction to generate a next noisy input to the denoiser model.

19. The non-volatile machine-readable media of claim 12, wherein the energy-based model comprises a bidirectional transformer.

20. The non-volatile machine-readable media of claim 19, wherein the energy-based model is configured via noise contrastive estimation.

21. The non-volatile machine-readable media of claim 12, wherein the energy-based model comprises an autoregressive model.
